(19) United States
(12) Patent Application Publication
(10) Pub. No.: US 2025/0058408 A1
(43) Pub. Date: Feb. 20, 2025

(54) MACHINING CONDITION DETERMINATION METHOD AND DETERMINATION DEVICE

(71) Applicant: Panasonic Intellectual Property Management Co., Ltd., Osaka (JP)

(72) Inventors: KAZUKI FUJIWARA, Osaka (JP); KOJI FUNAMI, Kyoto (JP); IZURU NAKAI, Osaka (JP); TATSURO SHIRAISHI, Osaka (JP)

(21) Appl. No.: 18/935,667

(22) Filed: Nov. 4, 2024

Related U.S. Application Data
(63) Continuation of application No. PCT/JP2023/002952, filed on Jan. 31, 2023.

(30) Foreign Application Priority Data
May 10, 2022 (JP) 2022-077795

(51) Int. Cl. B23K 26/03; B23K 26/21

(52) U.S. Cl. CPC B23K 26/032; B23K 26/21

(57) ABSTRACT

A determination method of a machining condition includes detecting, by using an optical sensor, at least one component of heat radiation, visible light, and reflected light generated at a welded portion provided on a surface of a workpiece by emission of a laser beam on the workpiece, acquiring a signal indicating a change in the at least one component in a time section from a start of welding to an end of welding of the workpiece, calculating a feature quantity based on a signal intensity of the signal in a predetermined section in the time section, determining, as the machining condition, presence or absence of a gap generated between superposed surfaces of the workpiece in an irradiation direction of the laser beam by inputting the calculated feature quantity to a determination model for determining the machining condition, and outputting the determined presence or absence of the gap as a determination result. The determination model is constructed based on training data including the feature quantity calculated under a plurality of conditions in which the machining condition changes and observed presence or absence of the gap in association with each other.

### TECHNICAL FIELD

The present disclosure relates to a determination method and a determination device of a machining condition in laser machining for lap welding.

### BACKGROUND ART

PTL 1 discloses a method which is applied to laser welding in which a workpiece is irradiated with a laser beam repeatedly generated in a pulse shape and determines a welding state such as good or poor welding for each workpiece. In the method in PTL 1, the intensity of plasma light and reflected light emitted from the workpiece during laser welding is detected as detection light intensity, and a feature value is extracted for each pulse of the laser beam based on the detection light intensity in an extraction section set in advance in a single cycle corresponding to a single pulse of the laser beam. An average value of the detection light intensity, a change amount by a difference process, or the like is calculated as the feature value. In the method of PTL 1, for each workpiece, a lower limit value of the reflected light or an upper limit value of the plasma light as an extreme value of the feature value for each pulse repeatedly generated is compared with a preset threshold value of a feature value of a non-defective product and a defective product, and a welding defect is determined as a welding state.

### CITATIONS LIST

### Patent Literature

PTL 1: Unexamined Japanese Patent Publication No. 2000-153379

### SUMMARY OF THE INVENTION

In laser welding, due to a change in a machining condition such as generation of a gap between superposed surfaces of workpieces (between workpieces) in an irradiation direction of the laser beam, a joint area may be reduced to cause a joint failure. In such a case, detailed analysis of the machining condition is required in order to investigate a cause of the joint failure. On the other hand, in the determination of the welding defect based on a predetermined threshold value for separating whether welding is good or bad for each workpiece as in PTL 1, it is difficult to determine a detailed machining condition such as the presence or absence of the gap generated between the workpieces during lap welding.

The present disclosure provides a determination method and a determination device capable of determining in detail a machining condition in laser machining for lap welding.

According to one aspect of the present disclosure, a determination method of a machining condition in laser machining for lap welding is provided. The present method includes detecting, by using an optical sensor, at least one component of heat radiation, visible light, and reflected light generated at a welded portion provided on a surface of a workpiece by emission of a laser beam on the workpiece, acquiring a signal indicating a change in the at least one component in a time section from a start of welding to an end of welding of the workpiece, calculating a feature quantity based on a signal intensity of the signal in a predetermined section in the time section, determining, as the machining condition, presence or absence of a gap generated between superposed surfaces of the workpiece (between workpieces) in an irradiation direction of the laser beam by inputting the calculated feature quantity to a determination model for determining the machining condition, and outputting the determined presence or absence of the gap as a determination result. The determination model is constructed based on training data including the feature quantity calculated under a plurality of conditions in which the machining condition changes and observed presence or absence of the gap in association with each other.

According to one aspect of the present disclosure, a determination device of a machining condition in laser machining for lap welding is provided. The determination device includes an arithmetic circuit and a communication circuit. The communication circuit receives a signal generated by an optical sensor detecting at least one component of heat radiation, visible light, and reflected light generated at a welded portion provided on a surface of a workpiece by emission of a laser beam on the workpiece. The signal indicates a signal indicating a change of the at least one component in a time section from a start of welding to an end of welding of the workpiece. The arithmetic circuit acquires the signal by the communication circuit, calculates a feature quantity based on a signal intensity of the signal in a predetermined section in the time section, determines, as the machining condition, presence or absence of a gap generated between superposed surfaces of the workpiece (between workpieces) in an irradiation direction of the laser beam by inputting the calculated feature quantity to a determination model for determining the machining condition, and outputs the determined presence or absence of the gap as a determination result. The determination model is constructed based on training data including the feature quantity calculated under a plurality of conditions in which the machining condition changes and observed presence or absence of the gap in association with each other.

According to the determination method and the determination device of the present disclosure, the presence or absence of the gap between the workpieces in the irradiation direction of the laser beam is determined. As a result, the machining condition in laser machining for lap welding can be determined in detail.

### BRIEF DESCRIPTION OF THE DRAWINGS

FIG. 1 is a diagram illustrating an overview of a determination system according to a first exemplary embodiment of the present disclosure.

FIG. 2 is a diagram illustrating a configuration of a laser machining device of the determination system.

FIG. 3 is a diagram illustrating a configuration of a spectral device of the determination system.

FIG. 4 is a block diagram illustrating a configuration of the determination device of the determination system.

FIG. 5 is a flowchart illustrating a determination process of the determination device.

FIG. 6 is a diagram for explaining a signal acquired by the determination device.

FIG. 7 is a diagram for explaining a determination model process in the determination device.

FIG. 8 is a diagram for explaining a process of calculating a feature quantity in the determination device.

FIG. 9 is a flowchart illustrating a training process for the determination model.

FIG. 10 is a diagram for explaining training data for the determination model.

### DESCRIPTION OF EMBODIMENT

A method for determining a laser machining condition according to a first aspect of the present disclosure is a method for determining a machining condition in laser machining for lap welding. The method includes detecting, by using an optical sensor, at least one component of heat radiation, visible light, and reflected light generated at a welded portion provided on a surface of a workpiece by emission of a laser beam on the workpiece, acquiring a signal indicating a change in the at least one component in a time section from a start of welding to an end of welding of the workpiece, calculating a feature quantity based on a signal intensity of the signal in a predetermined section in the time section, determining, as the machining condition, presence or absence of a gap generated between superposed surfaces of the workpiece in an irradiation direction of the laser beam by inputting the calculated feature quantity to a determination model for determining the machining condition, and outputting the determined presence or absence of the gap as a determination result. The determination model is constructed based on training data including the feature quantity calculated under a plurality of conditions in which the machining condition changes and observed presence or absence of the gap in association with each other.

According to a second aspect of the present disclosure, in the method for determining a laser machining condition according to the first aspect, the feature quantity includes at least one of a signal intensity decrease amount, which indicates a degree of decrease in the signal intensity of the reflected light, and an integral value of the signal intensity.

According to a third aspect of the present disclosure, in the method for determining a laser machining condition according to the second aspect, the calculating of the feature quantity includes calculating an average intensity of a signal corresponding to a change in the reflected light in a time section at a peak output after rising of a laser output at which the laser beam oscillates and before falling of the laser output, the predetermined section includes a section calculated with a time when the signal of the reflected light first reaches the average intensity from a peak intensity as an initial time and with a time when the signal of the reflected light again reaches the average intensity as a termination time, and the signal intensity decrease amount is a value obtained by subtracting, from the average intensity, a minimum value of the calculated signal intensity in the section.

According to a fourth aspect of the present disclosure, in the method for determining a laser machining condition according to any one of the first to third aspects, the feature quantity includes a feature quantity corresponding to a time fluctuation in the signal intensity of the reflected light in a time section at a peak output after rising of a laser output at which the laser beam oscillates and before falling of the laser output.

According to a fifth aspect of the present disclosure, in the method for determining a laser machining condition according to any one of the first to fourth aspects, the feature quantity includes an integral value of the signal intensity of at least one of the heat radiation and the visible light in a time section at a peak output after rising of a laser output at which the laser beam oscillates and before falling of the laser output.

According to a sixth aspect of the present disclosure, in the method for determining a laser machining condition according to any one of the first to fifth aspects, the training data further includes a numerical value related to a melting width calculated by measuring an appearance shape of the welded portion after welding or an image obtained by capturing the welded portion after welding in association with the presence or absence of the gap.

According to a seventh aspect of the present disclosure, in the laser machining condition determination method according to any one of the first to sixth aspects, the determination model includes a trained model generated by machine learning using training data including a feature quantity calculated from a signal based on the at least one component detected by performing the laser machining under each condition of a plurality of conditions in which the machining condition changes and the presence or absence of the gap under the each condition, the feature quantity and the presence or absence of the gap being associated with each other.

According to an eighth aspect of the present disclosure, in the method for determining a laser machining condition according to any one of the first to seventh aspects, the determining of the presence or absence of the gap includes determining a gap amount indicating a size of the gap in the irradiation direction of the laser beam, the gap amount of the gap includes a numerical value indicating a displacement amount with a state where the gap is not generated between the superposed surfaces of the workpiece as a reference, and the training data of the determination model includes the feature quantity calculated under a situation where the gap is generated and the gap amount of the generated gap in association with each other.

According to a ninth aspect of the present disclosure, there is provided a device that determines a laser machining condition. The present determination device is a device that determines a machining condition in laser machining for lap welding. The device includes an arithmetic circuit, and a communication circuit that receives a signal generated by an optical sensor detecting at least one component of heat radiation, visible light, and reflected light generated at a welded portion provided on a surface of a workpiece by emission of a laser beam on the workpiece. The signal indicates a signal indicating a change in the at least one component in a time section from a start of welding to an end of welding of the workpiece. The arithmetic circuit acquires the signal by the communication circuit, calculates a feature quantity based on a signal intensity of the signal in a predetermined section in the time section, determines, as the machining condition, presence or absence of a gap generated between superposed surfaces of the workpiece in an irradiation direction of the laser beam by inputting the calculated feature quantity to a determination model for determining the machining condition, and outputs the determined presence or absence of the gap as a determination result. The determination model is constructed based on training data including the feature quantity calculated under a plurality of conditions in which the machining condition changes and observed presence or absence of the gap in association with each other.

Exemplary embodiments will be described below in detail with reference to some drawings, as appropriate. Descriptions more in detail than necessary may not be described. For example, detailed descriptions of already well-known matters and duplicated description of substantially identical configurations may not be described. These are to avoid an unnecessarily redundant description and to facilitate understanding of a person skilled in the art. Note that, the attached drawings and the following description are presented by the inventors of the present disclosure so that those skilled in the art can fully understand the present disclosure, and are not intended to limit the subject matter as described in the claims.

### First Exemplary Embodiment

In a first exemplary embodiment, as an example of using a determination method and a determination device according to the present disclosure, a determination system will be described that detects a component of light generated in laser machining for lap welding, acquires a signal based on the detected component, and determines a machining condition.

### 1. Configuration

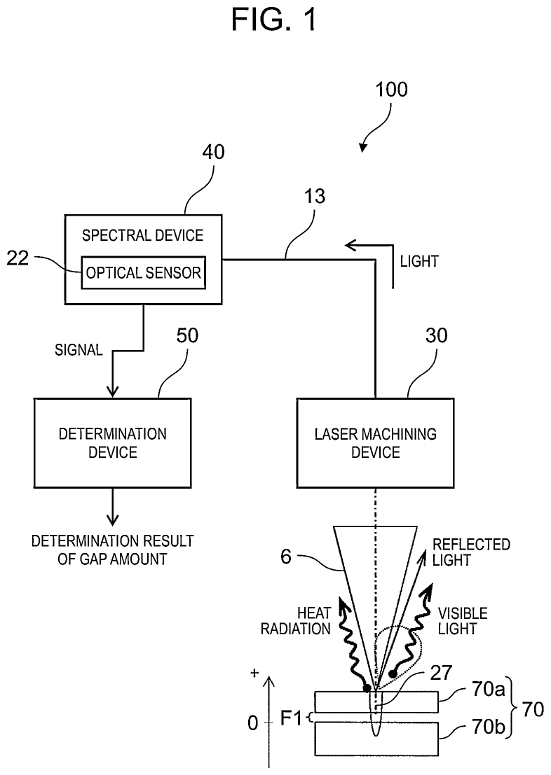

The determination system according to the first exemplary embodiment will be described with reference to FIG. 1. FIG. 1 is a diagram illustrating an overview of determination system 100 according to the exemplary embodiment.

### 1-1. System Overview

Determination system 100 includes laser machining device 30 that performs laser machining for lap welding, spectral device 40 for detecting a component of light, and determination device 50. Determination device 50 is an example of a determination device according to the present disclosure. Workpiece 70 of the lap welding is, for example, a workpiece made of metal, and includes two members 70a, 70b (hereinafter, referred to as “upper member 70a” and “lower member 70b” with laser machining device 30 side as an upper side) superposed in an irradiation direction of laser beam 6. When laser beam 6 is applied, heat radiation in a near-infrared region due to a temperature rise, and emission of light unique to metal or plasma emission mainly as a visible light component are generated. In addition, a par of laser beam 6 that does not contribute to machining is reflected to be a return light. As described above, emission of laser beam 6 by laser machining device 30 on workpiece 70 generates heat radiation, visible light, and reflected light at molten portion 27, which is an example of a welded portion formed in workpiece 70.

The generated light is condensed in laser machining device 30 and is transmitted to spectral device 40 through optical fiber 13 connecting laser machining device 30 to spectral device 40. The light transmitted to spectral device 40 is dispersed into components of the heat radiation, the visible light, and the reflected light, and the dispersed components are detected by optical sensor 22 of spectral device 40 and are converted into signals.

Here, for example, gap F1 is generated between upper member 70a and lower member 70b of workpiece 70, and a welding failure may occur. In this case, it is conceivable that the signal of each component changes in accordance with the generation of gap F1. Therefore, when the signal is received from spectral device 40, determination device 50 determines, as a machining condition, presence or absence of gap F1 based on the signal, and outputs a determination result.

Determination device 50 of the present exemplary embodiment determines the presence or absence of gap F1 based on a size of gap F1 in the irradiation direction of laser beam 6, that is, a gap amount. The gap amount of gap F1 is defined by, for example, a displacement amount (+) from an upper surface of lower member 70b to a lower surface of upper member 70a in a superposed surface of workpiece 70 with a state where gap F1 is not generated as a reference value “0”. For example, in a case where the gap amount is “0”, it can be determined that gap F1 is not present, and in a case where the gap amount is not “0”, it can be determined that gap F1 is present. The presence of gap F1 is synonymous with the gap amount being larger than 0, and the absence of gap F1 is synonymous with the gap amount being 0.

### 1-2. Configuration of Laser Machining Device

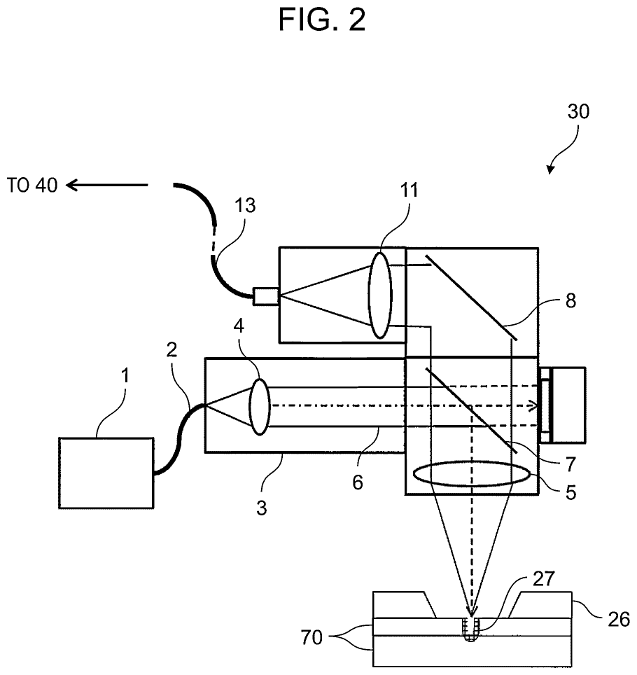

FIG. 2 is a diagram illustrating a configuration of laser machining device 30 of the present exemplary embodiment. Laser machining device 30 includes laser oscillator 1, laser transmission fiber 2, lens barrel 3, collimating lens 4, condenser lenses 5 and 11, first mirror 7, and second mirror 8.

Laser oscillator 1 supplies light for generating pulsed laser beam 6 having a wavelength of, for example, about 1070 nanometers (nm). The light supplied from laser oscillator 1 is amplified while being transmitted through laser transmission fiber 2, passes through collimating lens 4 for obtaining a parallel beam, forms into laser beam 6, and travels straight in lens barrel 3. Lens barrel 3 constitutes a machining head of laser machining device 30.

Laser beam 6 is reflected by first mirror 7 except for a part transmitted through first mirror 7, and reflected laser beam 6 is condensed by condenser lens 5 and is emitted on workpiece 70 fixed on a scanning table (not illustrated) by hold jig 26. As a result, laser machining for lap welding of workpieces 70 is performed. Note that, the wavelength of laser beam 6 is not particularly limited to 1070 nm. A wavelength having a high absorption rate in a material is preferably used.

By emission of laser beam 6, heat radiation from workpiece 70, visible light of plasma emission, and reflected light of laser beam 6 are generated at molten portion 27. These light components are transmitted through first mirror 7, are reflected by second mirror 8, are condensed by condenser lens 11, and are then transmitted to spectral device 40 through optical fiber 13. Note that, a part of light transmitted through second mirror 8 may be detected by a camera or a sensor.

### 1-3. Configuration of Spectral Device

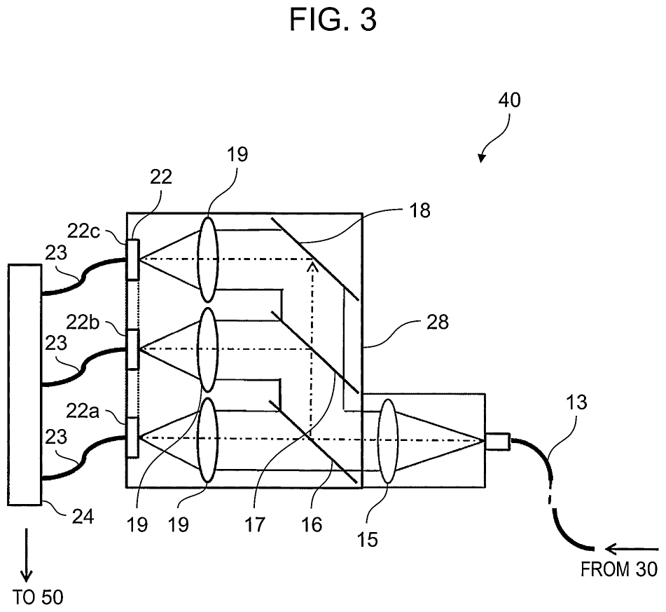

FIG. 3 is a diagram illustrating a configuration of spectral device 40 of the present exemplary embodiment. Spectral device 40 includes, in housing 28, collimating lens 15, third mirror 16, fourth mirror 17, fifth mirror 18, condenser lenses 19, 20, 21, optical sensor 22, transmission cables 23, and controller 24. Housing 28 prevents other light rays from entering from outside spectral device 40 and leakage of light from inside spectral device 40.

Collimating lens 15 changes the light transmitted from laser machining device 30 through optical fiber 13 into parallel light again. Third mirror 16 lets visible light having a wavelength of 400 nm to 700 nm, for example, pass therethrough and reflects the rest of the light components. Fourth mirror 17 reflects the reflected light of laser beam 6 having a wavelength of about 1070 nm, for example, and transmits the rest of the light components. Fifth mirror 18 reflects heat radiation having a wavelength of 1300 nm to 1550 nm, for example.

The light having passed through collimating lens 15 is dispersed by third mirror 16, fourth mirror 17, and fifth mirror 18 into components of visible light, reflected light, and heat radiation, and the dispersed components are condensed by condenser lenses 19 to 21. Note that, any selected bandpass filter may be disposed in each of optical paths respectively coming from third mirror 16, fourth mirror 17, and fifth mirror 18 to select a certain wavelength of the light that passes through the bandpass filter.

Optical sensor 22 includes, for example, optical sensors 22a, 22b, 22c each having high sensitivity for a wavelength that differs among optical sensors 22a, 22b, 22c. Optical sensors 22a, 22b, 22c detect components of the visible light, the reflected light, and the heat radiation condensed by condenser lenses 19 to 21, respectively, and each generate an electric signal corresponding to the intensity of the detected light. Note that, optical sensor 22 may be a single optical sensor capable of detecting the intensity of each wavelength.

The electrical signal generated by optical sensor 22 is transmitted to controller 24 via transmission cables 23. Controller 24 is a hardware controller, and integrally controls all the operations of spectral device 40. Controller 24 includes a CPU and a communication circuit, and transmits the electric signal received from optical sensor 22 to determination device 50. Controller 24 includes, for example, an AD converter, and converts an analog electric signal into a digital signal (also simply referred to as “signal”). Note that, the sampling period of conversion into a digital signal is preferably, for example, 1/100 or less of a time for performing output control of laser beam 6 from the viewpoint of securing a sufficient number of samples to capture a feature of processing and local behavior of a physical quantity for determining the machining condition.

### 1-4. Configuration of Determination Device

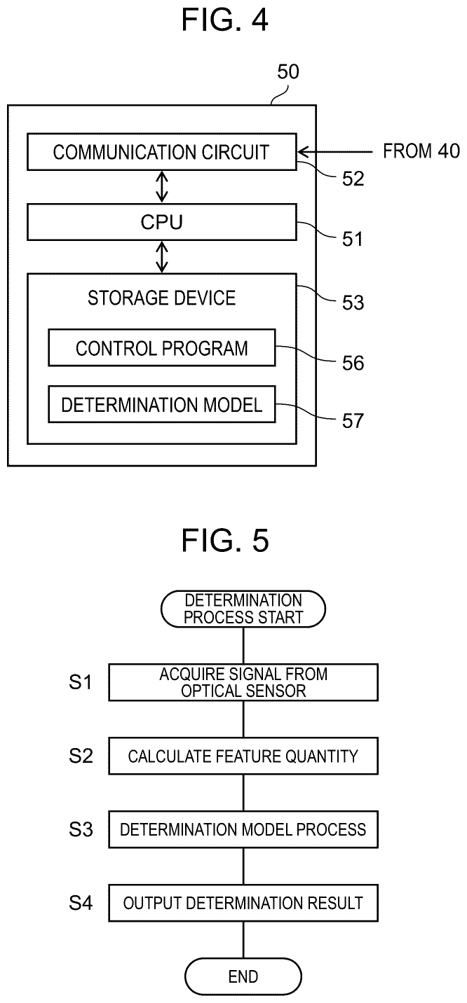

FIG. 4 is a block diagram illustrating a configuration of determination device 50 of the present exemplary embodiment. Determination device 50 is, for example, an information processing device such as a computer. Determination device 50 includes CPU 51 that performs arithmetic processing, communication circuit 52 for communication with other devices, and storage device 53 that stores data and a computer program.

CPU 51 is an example of an arithmetic circuit of determination device 50 of the present exemplary embodiment. CPU 51 implements predetermined functions including training and execution of determination model 57 by executing control program 56 stored in storage device 53. Determination device 50 implements a function as determination device 50 of the present exemplary embodiment by CPU 51 executing control program 56. Note that, the arithmetic circuit configured as CPU 51 in the present exemplary embodiment may be implemented by a processor of various kinds such as an MPU and a GPU, or may be configured by one or more processors. In addition, the arithmetic circuit may be a hardware circuit such as a dedicated electronic circuit or a reconfigurable electronic circuit designed to realize the above-described functions, or may be constituted by various semiconductor integrated circuits such as a GPGPU, a TPU, a DSP, a microcomputer, an FPGA, and an ASIC.

Communication circuit 52 is a communication circuit that performs communication in accordance with a standard such as IEEE 802.11, 4G, and 5G. Communication circuit 52 may perform wired communication in accordance with a standard such as Ethernet (registered trademark). Communication circuit 52 is connectable to a communication network such as the Internet. In addition, determination device 50 may directly communicate with another device via communication circuit 52, or may communicate via an access point. Note that, communication circuit 52 may be configured to be able to communicate with other devices without a communication network. For example, communication circuit 52 may include a connection terminal such as a USB (registered trademark) terminal and an HDMI (registered trademark) terminal. Communication circuit 52 receives various signals corresponding to the light components detected from spectral device 40, for example.

Storage device 53 is a storage medium that stores a computer program and data necessary for implementing a function of determination system 100, and stores control program 56 executed by CPU 51 and data of various kinds. Storage device 53 stores the signal received from spectral device 40, and stores determination model 57 after determination model 57 is constructed. Determination model 57 determines the gap amount of gap F1 based on the signal from spectral device 40. Details of determination model 57 will be described later.

Storage device 53 is configured as, for example, a magnetic storage device such as a hard disk drive (HDD), an optical storage device such as an optical disk drive, or a semiconductor storage device such as an SSD. Storage device 53 may include a temporary storage element configured by a RAM such as a DRAM and an SRAM, or may function as an internal memory of CPU 51.

### 2. Operation

In determination system 100 having the above configuration, for example, as illustrated in FIG. 1, spectral device 40 detects, by optical sensor 22, the components of the heat radiation, the visible light, and the reflected light generated at molten portion 27 by emission of laser beam 6. Spectral device 40 transmits a signal corresponding to the intensity of each detected component to determination device 50. The operation of determination device 50 of present system 100 will be described below.

### 2-1. Determination Process

Hereinafter, a determination process of determining the gap amount of gap F1 as the machining condition in determination device 50 will be described with reference to FIGS. 5 to 8.

FIG. 5 is a flowchart illustrating the determination process in determination device 50 of the present exemplary embodiment. Each process in the flowchart is executed by, for example, CPU 51 of determination device 50. The flowchart starts by, for example, a user of determination system 100 giving a predetermined manipulation input for starting the determination process to an input device connected via communication circuit 52.

First, CPU 51 acquires, by communication circuit 52, signals corresponding to the components of the heat radiation, the visible light, and the reflected light detected by optical sensor 22 of spectral device 40 (S1).

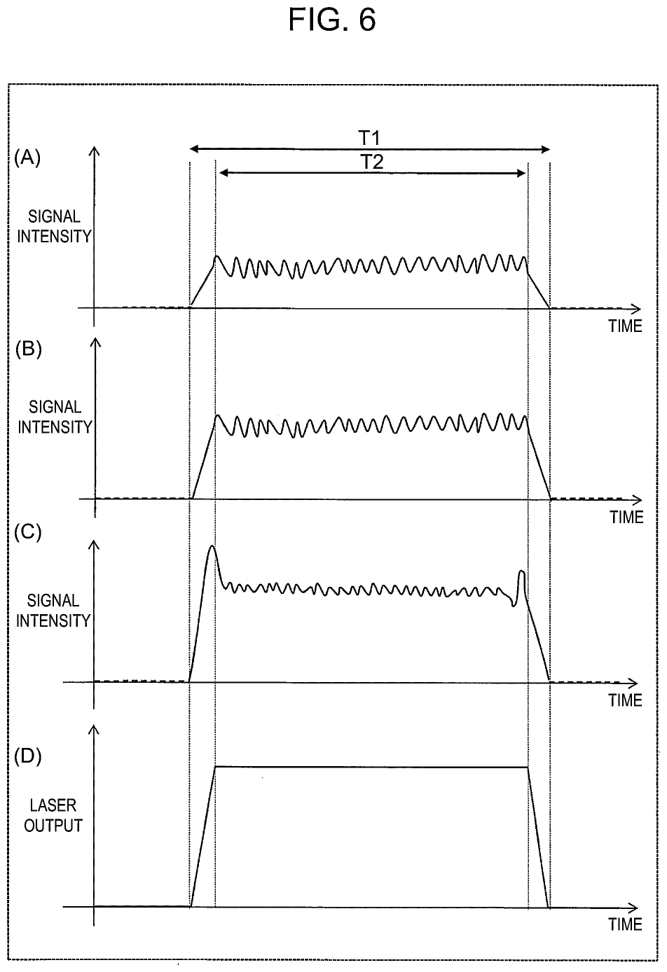

FIG. 6 is a diagram for explaining a signal acquired by determination device 50. Parts (A), (B), and (C) of FIG. 6 illustrate signal waveforms respectively corresponding to intensities of the heat radiation, the visible light, and the reflected light. Part (D) of FIG. 6 illustrates an output of laser beam 6 emitted to workpiece 70. Signals in parts (A) to (C) of FIG. 6 respectively correspond to heat radiation, visible light, and reflected light generated by a laser output. In parts (A) to (D) of FIG. 6, a horizontal axis represents time, and a vertical axis represents signal intensity (in parts (A) to (C) of FIG. 6) or the laser output (in part (D) of FIG. 6). In addition, time section T1 indicates a time section corresponding to a single pulse of laser beam 6, and time section T2 indicates a time section of a peak output not including a rise and a fall of the laser output.

In laser machining device 30 of the present exemplary embodiment, welding is performed for each workpiece 70 in time section T1 corresponding to the single pulse of laser beam 6. In step S1 of FIG. 5, CPU 51 acquires a signal indicating a change in each component of the heat radiation, the visible light, and the reflected light in time section T1 from the start of welding to the end of welding for each workpiece 70 as illustrated in parts (A) to (C) of FIG. 6.

Subsequently, CPU 51 calculates a feature quantity to be input to determination model 57 based on the signal intensity of the acquired signal (S2). Details of feature quantity calculation (S2) will be described later.

After the feature quantity is calculated (S2), CPU 51 performs process (S3) of determining the gap amount of gap F1 by inputting the feature quantity to determination model 57. In the present exemplary embodiment, in determination model process (S3), CPU 51 determines, as the gap amount, a numerical value indicating a displacement amount between the superposed surfaces of workpiece 70 (also referred to as “between workpieces”). Note that, a category or the like in which the magnitude of the gap amount is classified may be determined as the gap amount.

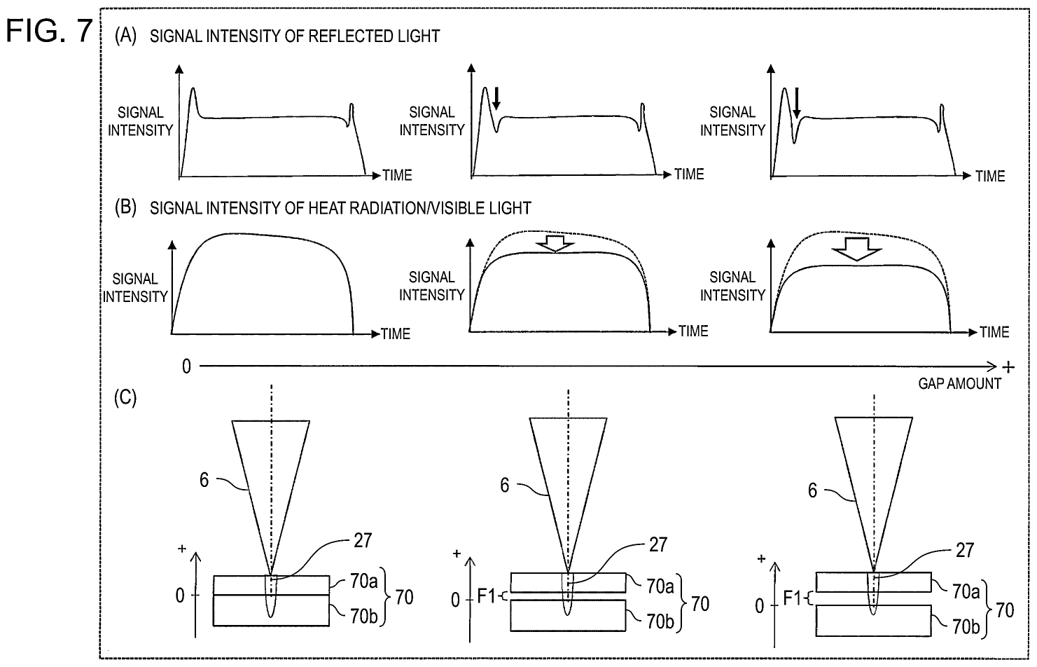

FIG. 7 is a diagram for explaining determination model process (S3). Part (A) of FIG. 7 illustrates a waveform of each signal intensity of the reflected light detected in each welding machining in a case where the gap amount of gap F1 is on a “0” side or a plus (+) side as the displacement amount with the reference similar to FIG. 1. Part (B) of FIG. 7 illustrates a waveform of each signal intensity of the heat radiation or the visible light detected similarly to part (A) of FIG. 7. (C) of FIG. 7 illustrates a positional relationship between the gap amount of gap F1 and members 70a, 70b of workpiece 70.

Determination model process (S3) is performed by determination model 57 trained based on a correspondence relationship between the signal waveform and the gap amount of gap F1 as illustrated in FIG. 7. The knowledge obtained by the inventors of the technology according to the present disclosure regarding the correspondence relationship between the signal waveform and the gap amount of gap F1 will be described below with reference to FIG. 7.

As illustrated in (A) of FIG. 7, when gap F1 is generated, the signal intensity of the reflected light temporarily decreases, and the amount of decrease in the signal intensity also increases as the gap amount increases. With regard to the cause, at the start of welding machining, a surface of workpiece 70 melts and evaporates by emission of laser beam 6 and a cavity (keyhole) is formed in the surface. With regard to the signal waveform of the reflected light, it is considered that when laser beam 6 melts upper member 70a and lower member 70b of workpiece 70, light leakage from the keyhole to gap F1 in molten portion 27 and melting of molten portion 27 occur, and thus, the signal intensity decreases.

In addition, as illustrated in (B) of FIG. 7, with regard to the signal waveforms of the heat radiation light and the visible light, when the gap amount of gap F1 increases, the signal intensity decreases as a whole, and the amount of decrease in the signal intensity also increases as the gap amount increases. During laser welding, heat input by laser beam 6 is required, but when the gap amount of gap F1 increases, light leakage occurs in gap F1 or molten portion 27 melts down during forming of the keyhole. Thus, it is considered that the signal intensity decreases as a light emitting area of the heat radiation light and the visible light decreases.

Based on the above knowledge, the inventors of the present invention have estimated that the gap amount of gap F1 can be predicted from a signal corresponding to at least one component of the heat radiation, the visible light, and the reflected light by using the feature quantity of the signal intensity or the like. Therefore, the inventors of the present invention have constructed determination model 57 by using training data in which these feature quantities and the gap amount of gap F1 are associated with each other, and have performed the determination process by determination model 57.

According to determination model 57 constructed in this manner, when feature quantity (S2) calculated based on acquired signal (S1) is input, the determination result of the gap amount of gap F1 is output (S3). A process of constructing determination model 57 will be described later.

Referring back to FIG. 5, CPU 51 outputs the determination result of gap F1 determined by determination model process (S3) by communication circuit 52 (S4). The determination result can be received and displayed by, for example, an external information processing device or a display device. In addition, determination device 50 may include a display (for example, a display) capable of communicating with CPU 51 and display the determination result on the display.

Then, CPU 51 ends the flowchart in FIG. 5. The flowchart in FIG. 5 is repetitively executed, for example, whenever welding machining is performed for each workpiece 70.

According to the above determination process, determination device 50 of the present exemplary embodiment acquires the signal generated by optical sensor 22 of spectral device 40 (S1), calculates the feature quantity based on the signal intensity (S2), and inputs the calculated feature quantity to determination model 57 that determines the gap amount of gap F1 (S3). As a result, determination device 50 can determine in detail the gap amount of gap F1 of laser beam 6 as the machining condition in laser machining for lap welding.

### 2-1-1. Calculation of Feature Quantity

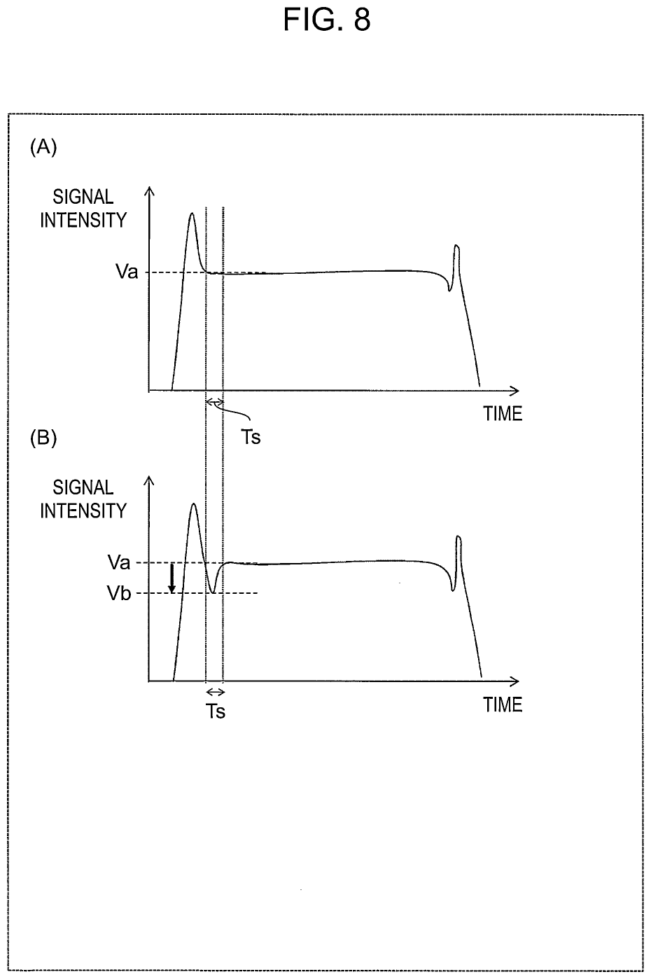

Details of step S2 in FIG. 5 will be described with reference to FIG. 8. FIG. 8 is a diagram for explaining process (S2) of calculating the feature quantity performed by determination device 50. Parts (A) and (B) of FIG. 8 illustrate temporal changes in the signal intensity of the signal corresponding to the reflected light on the vertical axis and the horizontal axis as in FIG. 6. (A) of FIG. 8 corresponds to the reflected light in a case where gap F1 is not present, and (B) of FIG. 8 corresponds to the reflected light in a case where gap F1 is present. After the signal is acquired (S1), CPU 51 performs a smoothing process of applying a smoothing filter to the signal, for example, in step S2. By the smoothing process, it is easy to calculate the feature quantity of the signal waveform in which the signal intensity finely fluctuates (see FIG. 6).

During irradiation with laser beam 6, the surface of workpiece 70 is melted and evaporated as described above, and thus, the cavity, that is, the keyhole is formed on the surface. With regard to the reflected light generated during irradiation with laser beam 6, when gap F1 is generated, light leakage and melting of molten portion 27 occur during the forming of the keyhole from the superposed surface of workpiece 70 (that is, an interface of the workpiece). Thus, as illustrated in (B) of FIG. 8, the light intensity decreases particularly during the forming of the keyhole. Therefore, in step S2, determination device 50 of the present exemplary embodiment first calculates, as the feature quantity, a signal intensity decrease amount corresponding to the decrease in the light intensity, that is, the amount of decrease in the signal intensity.

In the present exemplary embodiment, from the viewpoint of accurately reflecting the decrease in the signal intensity due to the generation of gap F1 in the feature quantity, the amount of decrease in the signal intensity is calculated based on an average value of signal intensities of signals acquired under a condition in which it is found that gap F1 is not generated as in (A) of FIG. 8, for example. For example, CPU 51 acquires the signal in advance, calculates average value Va of the signal intensities of the reflected light components in time section T2 at the peak output of laser beam 6, and stores the calculated signal in storage device 53 or the like. CPU 51 sets in advance time section Ts in which the decrease in the intensity of the signal acquired in step S1 is measured by using, for example, the signal for which average value Va is calculated. Time section Ts is a section calculated with a time when the signal intensity first reaches average value Va from an initial peak as an initial time and with a time when the signal intensity again reaches average value Va as a termination time, and is set to a period from the initial time to the termination time.

In step S2 of FIG. 5, CPU 51 performs an arithmetic process of subtracting minimum value Vb of the signal intensities of the signals acquired in step S1 from the calculated average value in preset time section Ts, for example. As a result, it is possible to extract the signal intensity decrease amount corresponding to the generation of gap F1, that is, information on a difference in the signal intensity due to the presence or absence of gap F1. In addition, it is considered that the magnitude of the difference corresponding to the gap amount of gap F1 can be extracted in accordance with the amount of decrease in the signal intensity of the reflected light. Note that, for example, whenever step S2 is executed, a process of unifying a setting time of time section Ts in which average value Va is calculated and a rise time of the signal waveform may be executed.

In addition, in the present exemplary embodiment, in step S2 of FIG. 5, CPU 51 further calculates, as the feature quantity, an integral value of the signal intensity of the reflected light within time section Ts. As a result, the integral value is used as the feature value in addition to the amount of decrease in the signal intensity due to the difference from average value Va, and thus, for example, even when an abnormal value of the signal intensity is suddenly generated, the gap amount of gap F1 can be determined more robustly.

In addition, in the present exemplary embodiment, in step S2 of FIG. 5, CPU 51 further calculates a variance value of the signal intensity of the reflected light in time section T2 when the output of laser beam 6 is the peak output. With regard to gap F1, since the variance value of the signal intensity, that is, ae temporal variation of an amplitude of the signal waveform tends to increase in proportion to the increase in the gap amount, the gap amount can be determined more accurately by using the variance value as the feature quantity.

In addition, in the present exemplary embodiment, in step S2 of FIG. 5, CPU 51 further calculates, for example, an integral value of the signal intensity in time section T2 for the reflected light, the heat radiation light, and the visible light generated during radiation with laser beam 6. When gap F1 is generated, the melting of molten portion 27 occurs, and thus, in particular, the heat radiation light and the visible light easily reflect a change in a molten state of a material of workpiece 70, and the light intensity decreases. As described above, since the signal intensity of each light component decreases as the gap amount increases, the determination can be performed by accurately reflecting a change in a light emission energy of gap F1 by using the integral value of each signal intensity as the feature quantity.

Further, an appearance shape of molten portion 27 on a surface of upper member 70a after welding may be measured, and in step S2, CPU 51 may calculate measurement information of a melting width of molten portion 27 in the measurement result or the feature quantity based on an image obtained by capturing the appearance shape. The melting width is defined as a width of molten portion 27 in a direction perpendicular to a traveling direction of welding machining. When gap F1 is generated, the melting of molten portion 27 occurs, and thus, the melting width of molten portion 27 to be formed decreases in proportion to the amount of melting of the molten portion. Thus, it is considered that the gap amount of gap F1 can be accurately determined by measuring the appearance shape of molten portion 27 after welding and using, as the feature quantity, the melting width or the image information of the appearance shape. For example, the melting width of molten portion 27 is used as the feature quantity, and thus, the determination can be performed by accurately reflecting the change in the light emission energy according to the gap amount of gap F1.

Note that, in step S2 of FIG. 5, only a part of each of the above-described feature quantities may be calculated, or any combination of the feature quantities may be calculated. In addition, as the feature quantity, the integral value of the signal intensity may be calculated only for some components of the heat radiation, the visible light, and the reflected light.

### 2-2. Training Process

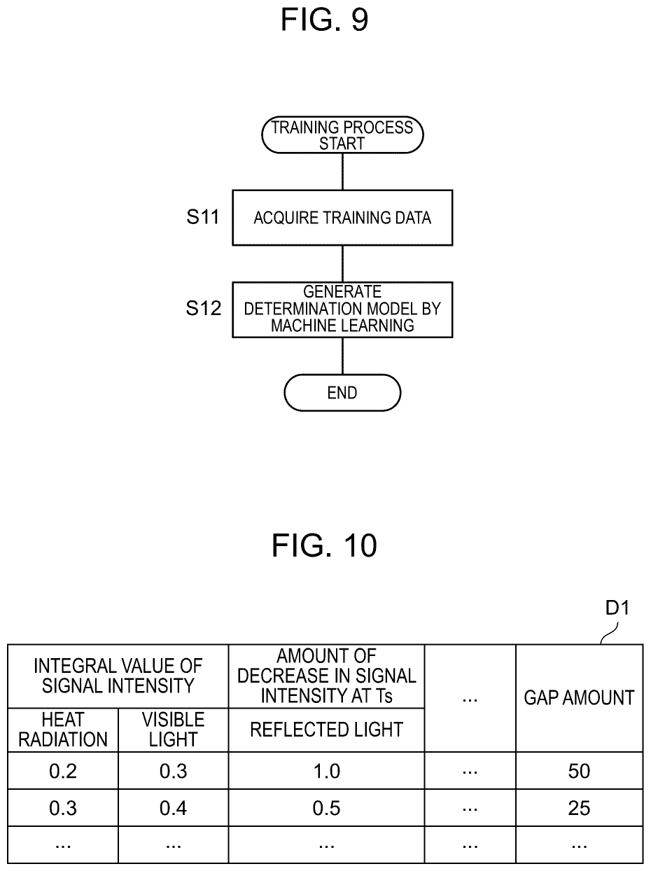

A training process for constructing determination model 57 will be described below with reference to FIGS. 9 and 10.

FIG. 9 is a flowchart illustrating a training process for determination model 57. Each process in the flowchart is executed by, for example, CPU 51 of determination device 50.

First, CPU 51 acquires, for example, training data previously stored in storage device 53 (S11).

FIG. 10 is a diagram for explaining training data D1 for determination model 57. Training data D1 is data in which feature quantities such the integral value of the signal waveform of the heat radiation and the visible light, the amount of decrease in the signal intensity of the reflected light, and the signal intensity (not illustrated) of each of these components are associated with the gap amount of gap F1. Training data D1 is constructed by calculating the feature quantities from the signals based on the components of the heat radiation, the visible light, and the reflected light detected during actual laser machining under a plurality of conditions where gap F1 changes and recording the feature quantities in association with the gap amount of gap F1 measured under each condition. Training data D1 may include the melting width obtained by measuring the appearance shape of molten portion 27 after welding and/or the image of the appearance shape in association with the gap amount of gap F1.

Referring back to FIG. 9, when training data D1 is acquired (S11), CPU 51 performs machine learning by using training data D1 and generates determination model 57 (S12). Determination model 57 is generated as a regression model based on, for example, linear regression, Lasso regression, ridge regression, decision tree, random forest, gradient boosting, support vector regression, Gaussian process regression, neural network, or k-nearest neighbor algorithm.

According to the above training process (S11 and S12), determination model 57 can be generated as a trained model for determining the gap amount of gap F1 from the feature quantities calculated based on the signals corresponding to the components of the heat radiation, the visible light, and the reflected light detected in the laser welding machining.

Note that, the training process for determination model 57 may be performed in an information processing device other than determination device 50. Determination device 50 may acquire an already constructed determination model by communication circuit 52 via, for example, a communication network. In addition, the training data of determination model 57 may include various feature quantities as described above in association with the presence or absence of gap F1 or a category indicating the classification of the magnitude of the gap amount. In this case, determination model 57 may be generated as various classification models by using the training data.

### 3. Effects

As described above, in the present exemplary embodiment, the determination process (S1 to S4) provides a method for determining the machining condition in laser machining for lap welding (method for determining the laser machining condition). The present method includes a step of detecting, by using optical sensor 22, at least one component of the heat radiation, the visible light, and the reflected light generated at molten portion 27 (an example of the welded portion) formed on the surface of workpiece 70 by the emission of laser beam 6 on workpiece 70, step (S1) of acquiring the signal indicating the change in the component in time section T1 as an example of the time section from the start of welding to the end of welding for each workpiece 70, step (S2) of calculating the feature quantity based on the signal intensity of the signal in a predetermined section in time section T1, step (S3) of determining the gap amount as an example of the presence or absence of gap F1 in an irradiation direction of laser beam 6 as the machining condition by inputting the calculated feature quantity to determination model 57 for determining the machining condition, and step (S4) of outputting the determined gap amount of gap F1 as a determination result. Determination model 57 is constructed based on training data D1 including the feature quantity calculated under the plurality of conditions in which the machining condition changes and an observed gap amount in association with each other.

According to the above method, the signal based on at least one of detected the heat radiation, the visible light, and the reflected light generated by the emission of laser beam 6 is acquired (S1), the feature quantity is calculated based on the signal intensity (S2), and determination is performed by determination model 57 (S3). As a result, the machining condition can be determined in detail by determination model 57 constructed by using training data D1 in which the feature quantity based on the signal intensity is associated with the gap amount of gap F1 as the machining condition.

In the present exemplary embodiment, the feature quantity includes at least one of the signal intensity decrease amount, which indicates the degree of decrease in the signal intensity of the reflected light, and the integral value of the signal intensity. As a result, it is possible to easily reflect the change in the signal intensity accompanying the generation of gap F1 in the determination of determination model 57.

In the present exemplary embodiment, step (S2) of calculating the feature quantity further includes a step of calculating average value Va as an example of an average intensity of the signal corresponding to a change in the reflected light in time section T2 at the peak output after rising of a laser output at which laser beam 6 oscillates and before falling of the laser output. The predetermined section in the present exemplary embodiment includes time section Ts calculated with the time when the signal of the reflected light first reaches average value Va from a peak intensity as the initial time and with the time when the signal of the reflected light again reaches average value Va as the termination time. The signal intensity decrease amount is a value obtained by subtracting minimum value Vb of the signal intensity in time section Ts from average value Va (see FIG. 8). As a result, for example, average value Va in the signal in a case where gap F1 is not generated is calculated, and minimum value Vb is calculated in the signal for which the presence or absence of gap F1 is to be determined. Accordingly, it is possible to calculate the difference in the signal intensity due to the presence or absence of gap F1 as the signal intensity decrease amount.

In the present exemplary embodiment, the feature quantity includes the variance value of the amplitude of the signal waveform indicating the signal intensity as an example of the feature quantity corresponding to the time variation in the signal intensity of the reflected light in time section T2 at the peak output of the laser output. As a result, it is possible to more accurately determine the gap amount by reflecting the tendency that the time variation of the amplitude of the signal waveform increases in accordance with the increase in the gap amount of gap F1.

In the present exemplary embodiment, the feature quantity includes the integral value of the signal intensity of at least one of the heat radiation and the visible light in the time section at the peak output of laser beam 6. As a result, as illustrated in (B) and (C) of FIG. 7, it is possible to easily determine the gap amount of gap F1 by reflecting the tendency of the signal intensity to decrease with the increase in the gap amount of gap F1 over a period in which the laser output continues.

In the present exemplary embodiment, training data D1 of determination model 57 further includes the numerical value related to the melting width calculated by measuring the appearance shape of molten portion 27 (an example of the welded portion) after welding, the image obtained by capturing molten portion 27, or both the numerical value and the image, as an example of the presence or absence of gap F1, in association with the gap amount. According to determination model 57 constructed by using such training data D1, the gap amount can be determined by using the image of the melting width and/or the appearance shape of molten portion 27 as the feature quantity.

In the present exemplary embodiment, determination model 57 includes a trained model generated (S11 and S12) by machine learning using training data D1 in which the feature quantity calculated from the signal based on the component of the light detected by performing laser machining under each condition of the plurality of conditions in which the gap amount of gap F1 changes is associated with the gap amount as an example of the presence or absence of gap F1 under each condition. As a result, determination model 57 for determining the gap amount of gap F1 as the machining condition is obtained from the feature quantity calculated based on the detected signal of the component.

In the present exemplary embodiment, step (S3) of determining the presence or absence of the gap includes determining the gap amount indicating the size of gap F1 in the irradiation direction of laser beam 6. The gap amount of gap F1 includes the numerical value indicating the displacement amount with a state where gap F1 between the superposed surfaces of workpiece 70 is not generated as a reference “0”. Training data D1 of determination model 57 includes the feature quantity calculated under the situation where gap F1 is generated and the gap amount of generated gap F1 in association with each other. As a result, the machining condition in laser machining can be determined in detail including how much gap F1 has been generated in the irradiation direction of laser beam 6.

In the present exemplary embodiment, the component detected by optical sensor 22 includes the heat radiation and the visible light. As a result, the integral value of the signal waveform of the signal corresponding to the heat radiation and the visible light can be used as the feature quantity. For example, since the change in the molten state of workpiece 70 is easily reflected in these components, the gap amount of gap F1 can be easily determined accurately.

In the present exemplary embodiment, the component detected by optical sensor 22 includes reflected light. As a result, the integral value of the signal intensity of the signal corresponding to the reflected light can be used as the feature quantity. Since the signal of the reflected light has a smaller time variation in the signal intensity, that is, a smaller variation in the signal intensity than other the component, it is possible to easily determine the gap amount of gap F1 accurately.

In determination system 100 of the present exemplary embodiment, determination device 50 is an example of a determination device for determining the machining condition in laser machining for lap welding. Determination device 50 includes CPU 51 as an example of an arithmetic circuit, and communication circuit 52. Communication circuit 52 receives the signal generated by optical sensor 22 detecting at least one component of the heat radiation, the visible light, and the reflected light generated at molten portion 27 (an example of the welded portion) formed on the surface of workpiece 70 by emission of laser beam 6 on workpiece 70. The signal is the signal indicating the change in the component in time section T1 as an example of the time section from the start of welding to the end of welding for each workpiece 70. CPU 51 acquires the signal by communication circuit 52 (S1), calculates the feature quantity based on the signal intensity of the signal in a predetermined section of time section T1 (S2), inputs the calculated feature quantity to determination model 57 for determining the machining condition, determines, as the machining condition, the gap amount as an example of the presence or absence of gap F1 in the irradiation direction of laser beam 6 (S3), and outputs the determined gap amount of gap F1 as a determination result (S4). When workpiece 70 is irradiated with laser beam 6, the gap amount of gap F1 is determined with a state where the gap is not generated as a reference “0” when workpiece 70 is irradiated with laser beam 6. Determination model 57 is constructed based on training data D1 including the feature quantity calculated under the plurality of conditions in which the machining condition changes and the gap amount as an example of the observed presence or absence of gap F1 in association with each other.

According to determination device 50 described above, the machining condition in laser machining for lap welding can be determined in detail by performing the determination method described above.

(Other exemplary embodiments) As described above, the exemplary embodiment has been described as an example of the art disclosed in the present application. The art according to the present disclosure is, however, not limited to the above exemplary embodiment, and is applicable to other exemplary embodiments suitably made by modification, replacement, addition, or omission, for example. In addition, a different exemplary embodiment can also be made by a combination of the components of the exemplary embodiments described above.

In the first exemplary embodiment, determination device 50 calculates, as the feature quantity, the integral value of the signal intensity of the reflected light, the heat radiation light, and the visible light in time section T2 at the peak output, and the like, in addition to the amount of decrease and the integral value of the signal intensity in time section Ts of the signal corresponding to the reflected light (S2). In the present exemplary embodiment, the feature quantity is not particularly limited thereto, and for example, only the amount of decrease in the signal intensity in time section Ts may be used, or any one of the signal intensity decrease amount and the integral value may not be included. In addition, the feature quantity does not include, for example, the integral value of the reflected light with respect to the signal intensity in time section T2, and may include the integral value of either or both of the heat radiation light and the visible light.

In the first exemplary embodiment, when the feature quantity is calculated (S2), determination device 50 calculates the feature quantity by smoothing the signal waveform corresponding to the signal intensity in advance. In the present exemplary embodiment, the feature quantity may be calculated without applying a smoothing process to the signal waveform.

In the first exemplary embodiment described above, an example in which, when the signal intensity decrease amount is calculated in feature quantity calculation (S2), average value Va of the signal intensity of the reflected light is calculated based on the signal intensity of the reflected light in a case where gap F1 is not generated has been described. In the present exemplary embodiment, the average value of the signal intensity is not necessarily limited to a case where gap F1 is not present, and may be calculated based on the signal intensity in a case where gap F1 is present. In this case, determination model 57 can be constructed by using the signal intensity decrease amount calculated as the feature quantity with the average value as a reference.

In the first exemplary embodiment, determination device 50 calculates, as the feature quantity, the integral value of the signal intensity of the reflected light, the heat radiation, and the visible light (S2). In the present exemplary embodiment, the feature quantity of the integral value of the signal intensity may be calculated based on a part of the signals of the reflected light, the heat radiation, or the visible light, and may be selected in consideration of, for example, the absorption rate of the material with respect to the wavelength of the laser output from laser oscillator 1 of laser machining device 30.

The present disclosure is not limited to the exemplary embodiments described above, and various modifications can be made. That is, exemplary embodiments obtained by combining technical means suitably modified by those skilled in the art also fall within the scope of the present disclosure.

### INDUSTRIAL APPLICABILITY

The present disclosure is applicable to a determination system for determining a machining condition in laser machining for lap welding, in particular, to a method and a device for determining a gap amount between workpieces.

### REFERENCE MARKS IN THE DRAWINGS

1: laser oscillator
2: laser transmission fiber
3: lens barrel
4: collimating lens
5, 11: condenser lens
6: laser beam
7: first mirror
8: second mirror
13: optical fiber
15: collimating lens
16: third mirror
17: fourth mirror
18: fifth mirror
19, 20, 21: condenser lens
22: optical sensor
23: transmission cable
24: controller
26: hold jig
27: molten portion
30: laser machining device
40: spectral device
50: determination device
51: CPU
52: communication circuit
53: storage device
56: control program
57: determination model
70: workpiece
F1: gap
D1: training data
100: determination system

1. A method for determining a machining condition in laser machining for lap welding, the method comprising:
detecting, by using an optical sensor, at least one component of heat radiation, visible light, and reflected light generated at a welded portion provided on a surface of a workpiece by emission of a laser beam on the workpiece;
acquiring a signal indicating a change in the at least one component in a time section from a start of welding to an end of welding of the workpiece;
calculating a feature quantity based on a signal intensity of the signal in a predetermined section in the time section;
determining, as the machining condition, presence or absence of a gap generated between superposed surfaces of the workpiece in an irradiation direction of the laser beam by inputting the calculated feature quantity to a determination model for determining the machining condition; and
outputting the determined presence or absence of the gap as a determination result,
wherein the determination model is constructed based on training data including the feature quantity calculated under a plurality of conditions in which the machining condition changes and observed presence or absence of the gap, the feature quantity and the presence or absence of the gap being associated with each other.

2. The method according to claim 1, wherein the feature quantity includes at least one of a signal intensity decrease amount and an integral value of the signal intensity, the signal intensity decrease amount indicating a degree of decrease in the signal intensity of the reflected light.

3. The method according to claim 2, wherein
the calculating of the feature quantity includes calculating an average intensity of a signal corresponding to a change in the reflected light in a time section at a peak output after rising of a laser output at which the laser beam oscillates and before falling of the laser output,
the predetermined section includes a section calculated with a time when the signal of the reflected light first reaches the average intensity from a peak intensity as an initial time and with a time when the signal of the reflected light again reaches the average intensity as a termination time, and
the signal intensity decrease amount is a value obtained by subtracting, from the average intensity, a minimum value of the calculated signal intensity in the section.

4. The method according to claim 1, wherein the feature quantity includes a feature quantity corresponding to a time fluctuation in the signal intensity of the reflected light in a time section at a peak output after rising of a laser output at which the laser beam oscillates and before falling of the laser output.

5. The method according to claim 1, wherein the feature quantity includes an integral value of the signal intensity of at least one of the heat radiation and the visible light in a time section at a peak output after rising of a laser output at which the laser beam oscillates and before falling of the laser output.

6. The method according to claim 1, wherein the training data further includes a numerical value related to a melting width calculated by measuring an appearance shape of the welded portion after welding or an image obtained by capturing the welded portion after welding, in association with the presence or absence of the gap.

7. The method according to claim 1, wherein the training data further includes both a numerical value related to a melting width calculated by measuring an appearance shape of the welded portion after welding and an image obtained by capturing the welded portion after welding, in association with the presence or absence of the gap.

8. The method according to claim 1, wherein the determination model includes a trained model generated by machine learning using training data including a feature quantity calculated from a signal based on the at least one component detected by performing the laser machining under each condition of a plurality of conditions in which the machining condition changes and the presence or absence of the gap under the each condition, the feature quantity and the presence or absence of the gap being associated with each other.

9. The method according to claim 1, wherein
the determining of the presence or absence of the gap includes determining a gap amount indicating a size of the gap in the irradiation direction of the laser beam,
the gap amount of the gap includes a numerical value indicating a displacement amount with a state where the gap is not generated between the superposed surfaces of the workpiece as a reference, and
the training data of the determination model includes the feature quantity calculated under a situation where the gap is generated and the gap amount of the generated gap in association with each other.

10. A device that determines a machining condition in laser machining for lap welding, the device comprising:
an arithmetic circuit; and
a communication circuit that receives a signal generated by an optical sensor detecting at least one component of heat radiation, visible light, and reflected light generated at a welded portion provided on a surface of a workpiece by emission of a laser beam on the workpiece,
wherein the signal is a signal indicating a change in the at least one component in a time section from a start of welding to an end of welding of the workpiece,
the arithmetic circuit
acquires the signal by the communication circuit,
calculates a feature quantity based on a signal intensity of the signal in a predetermined section in the time section,
determines, as the machining condition, presence or absence of a gap generated between superposed surfaces of the workpiece in an irradiation direction of the laser beam by inputting the calculated feature quantity to a determination model for determining the machining condition, and
outputs the determined presence or absence of the gap as a determination result, and
the determination model is constructed based on training data including the feature quantity calculated under a plurality of conditions in which the machining condition changes and observed presence or absence of the gap, the feature quantity and the presence or absence of the gap being associated with each other.
